(19) United States
(12) Patent Application Publication
(10) Pub. No.: US 2018/0301808 A1
(43) Pub. Date: Oct. 18, 2018

(54) Large Area Lightweight Electronically Scanned Array

(71) Applicant: SPAWAR Systems Center Pacific, San Diego, CA (US)

(72) Inventor: Randall B. Olsen, Carlsbad, CA (US)

(73) Assignee: United States of America as represented by Secretary of the Navy, San Diego, CA (US)

(21) Appl. No.: 15/486,667

(22) Filed: Apr. 13, 2017

(51) Int. Cl. H01Q 3/36; H01Q 21/22; H01Q 21/00

(52) U.S. Cl. CPC H01Q 3/36; H01Q 21/0025; H01Q 21/22

(57) ABSTRACT

A large area lightweight electronically scanned array and method for steering same. The array includes a plurality of sub-arrays. Each sub-array includes at least one radiating element and a planar, constrained radio frequency lens having an input and at least one output. Each sub-array also includes a switch device that has at least one input and an output. The switch device may selectively couple a signal source to the input of the planar, constrained radio frequency lens at least one radiating element. Each sub-array also includes a relative tuning device that is configured to adjust a phase, path length or time delay of a signal received from a signal source to the input of the planar, constrained radio frequency lens relative to another signal received from a signal source to the input of another planar, constrained radio frequency lens in one of the plurality of sub-arrays.

### STATEMENT OF GOVERNMENT INTEREST FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619)553-5118; email: ssc_pac_t2@navy.mil. Reference Navy Case No. 104,115.

### BACKGROUND OF THE INVENTION

This disclosure relates to phased array antennas, and more particularly, to electronically steerable phased array antennas.

High gain antenna arrays are becoming more widely used. For example, they may be used for sensing and/or transmitting purposes in satellites and spacecraft. They may also be used for other sensing and/or transmitting applications, including radar.

High gain antenna arrays have a drawback in that they may be heavy, and thus not suitable for applications where mass or size is a major concern. Spacecraft/satellite applications are examples of applications where both mass and size are major concerns. There is a need for a lightweight antenna that can be used for satellite/spacecraft applications. There is further a need for an antenna array that takes up minimal space, but covers a large area.

Electronically steerable phased array antennas have also increased in popularity. When such an array is steerable, the physical antenna may remain stationary. As a result, the antenna array may remain focused on a satellite, even when the antenna array is mounted on a moving platform. However, drawbacks exist to electronically steerable arrays. For example, electronically-steerable high gain antennas are not only heavy, but also expensive. Accordingly, there is a need for an electronically-steerable high gain antenna that is relatively inexpensive.

### BRIEF SUMMARY OF INVENTION

The present disclosure addresses the needs noted above by providing a large area lightweight electronically scanned array. The large area lightweight electronically scanned array includes a plurality of sub-arrays.

Each sub-array includes a planar, constrained radio frequency lens having an input and at least one output, wherein the at least one output is operably coupled to at least one radiating element. Each sub-array also includes a switch device having at least one input and an output. The switch device is configured to transmit a signal to the input of the planar, constrained radio frequency lens and to selectively couple a signal source to the input of the planar, constrained radio frequency lens.

Each sub-array also includes a relative tuning device that is configured to adjust a phase, path length or time delay of a signal received from a signal source to the input of the planar, constrained radio frequency lens relative to another signal received from a signal source to the input of another planar, constrained radio frequency lens in one of the plurality of sub-arrays. The relative tuning device includes a processor having instructions for adjusting at least one of phase, path length or time delay of a signal received from a signal source to the input of the planar, constrained radio frequency lens relative to another signal received from a signal source to the input of another planar, constrained radio frequency lens in one of the plurality of sub-arrays.

The relative tuning devices also includes a memory for storing said instructions for adjusting phase, path length or time delay of a signal received from a signal source to the input of the planar, constrained radio frequency lens relative to another signal received from a signal source to the input of another planar, constrained radio frequency lens in one of the plurality of sub-arrays.

These, as well as other objects, features and benefits will now become clear from a review of the following detailed description, the illustrative embodiments, and the accompanying drawings.

### BRIEF DESCRIPTION OF DRAWINGS

The accompanying drawings, which are incorporated in and form a part of the specification, illustrate example embodiments and, together with the description, serve to explain the principles of the large area lightweight electronically scanned array and method of steering the large area lightweight electronically scanned array. In the drawings:

FIG. 1A illustrates a large area lightweight electronically scanned array in an unfolded configuration in accordance with one embodiment of the present disclosure.

FIG. 1B illustrates a large area lightweight electronically scanned array in the process of being folded in accordance with one embodiment of the present disclosure.

FIG. 1C illustrates a large area lightweight electronically scanned array in a folded configuration in accordance with one embodiment of the present disclosure.

FIG. 2A shows elements of a sub-array in a large area lightweight electronically scanned array in accordance with one embodiment of the present disclosure.

FIG. 2B shows an example of radiating elements for a plurality of sub-arrays in a large area lightweight electronically scanned array in accordance with one embodiment of the present disclosure.

FIG. 3 illustrates a sub-array in accordance with one embodiment of the present disclosure.

FIGS. 4A and 4B illustrate block diagram representations of the various layers of the large area lightweight electronically scanned array in accordance with one embodiment of the present disclosure.

FIG. 5 is a flow chart of a method for steering a large area lightweight electronically scanned array in accordance with one embodiment of the present disclosure.

FIG. 6 is a method for relatively tuning a large area lightweight electronically scanned array in accordance with one embodiment of the present disclosure.

FIG. 7A illustrates a radiative pattern as a function of angle for an individual sub-array in accordance with one embodiment of the present disclosure.

FIG. 7B illustrates a radiative pattern as a function of angle for the plurality of sub-arrays in accordance with one embodiment of the present disclosure.

### DETAILED DESCRIPTION OF THE INVENTION

The present disclosure is directed to a large area lightweight electronically scanned array and a method for electronically steering same. The large area lightweight electronically scanned array comprises a plurality of smaller sub-arrays. Each sub-array includes a switch coupled to a planar, constrained radio frequency (PCRF) lens. Each sub-array may receive one or more radio frequency (RF) signals from a signal source. Each (RF) signal may be fed from the signal source via switch to one or more PCRF inputs of the PCRF lens in a sub-array. The PCRF lens has outputs, each of which operably couple each sub-array to one or more radiating elements.

Crude beam pointing happens in the PCRF lens by virtue of the switch position that is chosen, i.e., which beam port is selected. An operator may determine where on Earth the antenna should be pointed as a function of time. Then, computers may calculate all the geometry and determine the correct switch position that corresponds to that direction. Fine tuning of the steering process may occur via a relative tuning device. Fine tuning helps the sub-arrays to create a desired radiative pattern so that the beam can be effectively steered.

The relative tuning device is controlled by software having instructions for causing the PCRF lens to adjust one of a phase, path length or time delay of one signal relative to another signal at another PCRF lens in the array. By adjusting the phase angle, path length or time delay of signals received from or transmitted to the radiating elements, the antenna beam is effectively steered. Each adjustment is made for one of the plurality of sub-arrays in relation to another of the plurality of sub-arrays.

These sub-arrays cooperate with the relative tuning device to carry out a method for electronically steering the large area lightweight electronically scanned array. The sub-arrays are pointed by selecting the proper switch position which directs an input signal to an input port for a PCRF lens, such as a compact lens. The input port corresponds to the desired direction azimuthally in space. The relative tuning devices are adjusted to create the large array pattern with a much narrower beam than produced by any of the individual sub-arrays alone.

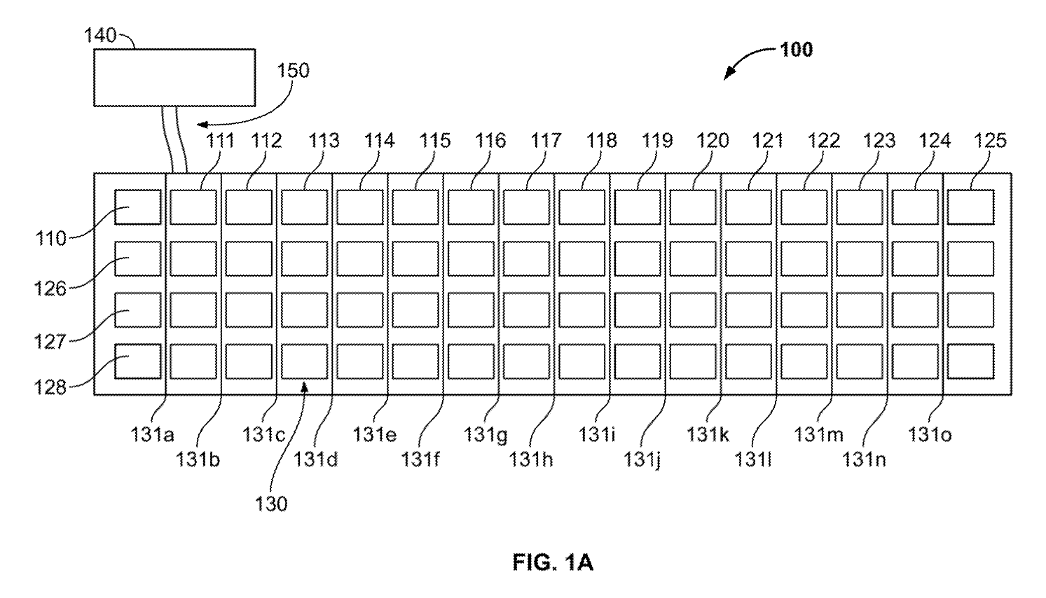

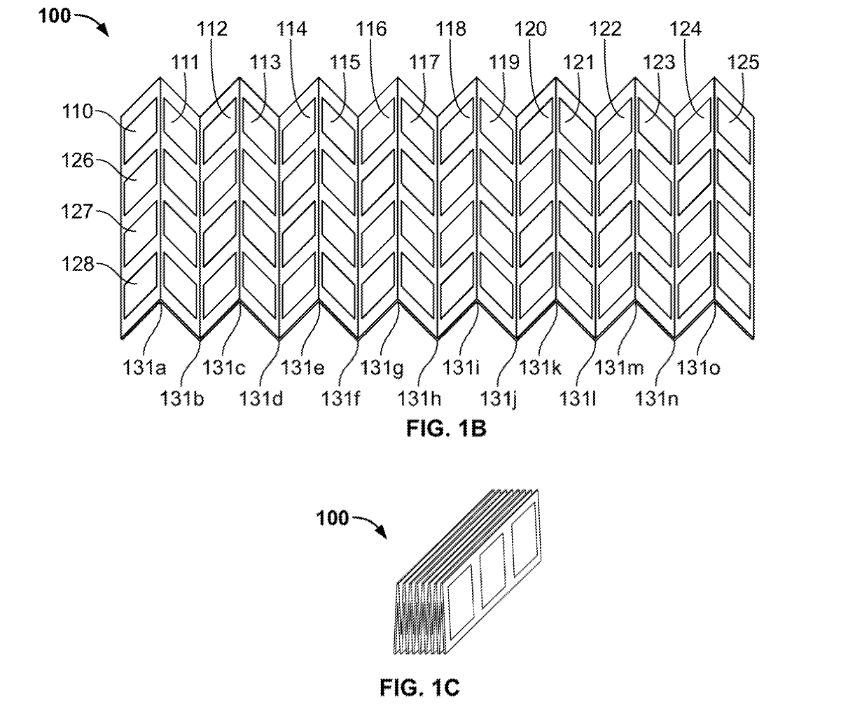

FIG. 1A illustrates a top view of a large area lightweight electronically scanned array in accordance with one embodiment of the present disclosure. As shown in FIG. 1A, the large area lightweight electronically scanned array 100 is comprised of a plurality of sub-arrays, e.g., 110-128, inclusive. In the present illustration, the quantity of sub-arrays is sixteen (16) across and four (4) down to form a 16 by 4 sub-array subsystem. The more sub-arrays, e.g., 110-128, the narrower the beam that can be formed. Sub-arrays 110-125, inclusive, are in the top row of arrays. Sub-arrays 110, 126, 127, 128 are in the leftmost column. Each of the plurality of sub-arrays may be connected to at least one other of the plurality of sub-arrays. However, connection between two or more sub-arrays, e.g., 110-128, is not necessary.

If connection between two or more of sub-arrays is desired, substrate 130 may support and facilitate interconnection of each of the plurality of sub-arrays, e.g., 110, to at least one other sub-array, e.g., 126, in the plurality of sub-arrays. In lieu of interconnections between sub-arrays, e.g., 110-128, each sub-array may connect to a “master” signal source that permits the transmission of signals to the sub-array. Substrate 130 may be formed of either a flexible material or a rigid material. If substrate 130 is formed of a thin, flexible material, such flexibility may facilitate folding of the large area lightweight electronically scanned array 100 so that it can be stored when not in use. The thin, flexible material used for substrate 130 may be a polyimide film that is on the order of twenty-five (25) microns to one hundred (100) microns thick. Kapton® polyimide films are an example of a commercially available material that may be used to form substrate 130.

Folding elements, e.g., 131a-131o, inclusive, may be provided with the array 100 in order to facilitate folding. The folding elements 131a-131o, inclusive, may incorporate hinges. In addition, or in lieu thereof, the substrate 130 may include hinges (not shown) to facilitate folding. In order to facilitate folding, in lieu of substrate 130, polyimide thread could be used to support the sub-arrays, e.g., 110-128, inclusive. The polyimide thread could be placed in tension, e.g., by a tension-producing structure.

The sub-arrays, e.g., 110, 120 could also be attached to one another via tape-like means. The edge of one sub-array, e.g., 110, could be attached to the edge of another sub-array, e.g., 120.

The sub-arrays e.g., 110, 120 could be segmented on the substrate 130 so that they are attached or interconnected with each other via columns. The substrate 130 could be folded into an accordion-type structure. The substrate is also designed to be unfoldable into a nice flat plane for use of the large area lightweight electronically scanned array 100.

In lieu of attaching all sub-arrays, e.g., 110, 120 together, each row of sub-arrays could be attached to each other. For example, each of the sub-arrays 110-125, inclusive, which are located in the top row of sub-arrays, could be attached to each other. Then, the remaining three rows could be attached to, or interconnected with, each other. However, connection between sub-arrays is not necessary. The sub-arrays just need to located in fixed positions relative to each other for the large area lightweight electronically scanned array 100 to work. If the sub-arrays are attached to each other, any number of configurations for attaching the sub-arrays are possible.

A signal source 140 may be located near large area lightweight electronically scanned array 100. Signal source 140 may transmit signals that are simultaneously fed to all of the sub-arrays, e.g., 110, 120, via a signal delivery medium such as a waveguide 150, which may be a coplanar waveguide. The sub-arrays e.g., 110, 120, may each connect to the signal source 140 to transmit these signals. This connection via waveguide 150 may be foldable. A coplanar waveguide is an example of a foldable way to deliver the signal to the sub-arrays from the “master” signal source 140. In the present illustration, waveguide 150 is a co-planar waveguide. In lieu of waveguide 150, other signal delivery media may be used, e.g., a coaxial cable, co-planar waveguide. Waveguide 150 may include metal strips (not shown in FIG. 1A) attached to the substrate 130. This co-planar waveguide may include thin layers of metal intimately bonded via adhesive with substrate 130. Other methods of attaching waveguides to a large area lightweight electronically scanned array 100 are known in the art. Soldering is one example of such a method.

The large area lightweight electronically scanned array 100 is a high gain array. In the present example, the 16×4 sub-array operates at a frequency of three gigahertz (3 GHz), has a length of thirty-two feet (32′), and a beam of about five degrees (5°) tall by less than one degree) (1° wide. The gain is 20 decibels-isotropic (dBi), plus six (6) dB tall and twelve dB wide, for a total of 38 dBi gain. The large area lightweight electronically scanned array 100 is electronically steerable. The interconnected sub-arrays, e.g., 110, 126, are tunable in relation to each other in order to facilitate electronic steering. Tunability results from functionality of a phase shifter, path length adjuster and/or time delay that is electronically controlled. This tunability is how the large array 100 can be made to be coherent. At least one radiating elements (not shown in FIG. 1A) is included in the sub-array 100.

As shown, each column of sub-arrays, e.g., 110, 126, 127, 128, is in a substantially rectangular shape due to the substrate underneath. However, it should be understood that one or more of the columns could be in other shapes, e.g. triangles, circles, or even irregular shapes. These shapes could facilitate array deployment by permitting the array 100 to be folded into a desired pattern. Such shapes could also be tailored to produce a desired beam pattern. In addition to the columns potentially taking on other shapes, the sub-arrays e.g., 110, 126, 127, 128, themselves could take on other shapes that are tailored to produce a desired beam pattern.

FIG. 1B is a side view of the array 100 of FIG. 1A as it is being folded via hinges or folding elements 131a-131o, inclusive. As noted earlier, the substrate 130 is thin, e. g., on the order of twenty-five microns to one hundred microns thick. As shown, when the substrate 130 is being folded, it may take on an accordion-like configuration. Folding elements 131a-1310 could include, or be controlled by, various elements that facilitate folding, unfolding and deployment of the array 100. For example, scissor linkages could be opened and closed either manually or automatically to facilitate folding. In the 16×4 array 100 shown in FIG. 1B, each column of sub-arrays, e.g., 110, 126, 127, 128, contains an equal amount of sub-arrays. Each row, e.g., 110-125 inclusive, also contains the same amount of sub-arrays. In lieu of the number of columns being equal and the number of rows being equal, the number of sub-arrays could vary by column and/or row in order to achieve the desired beam pattern.

FIG. 1C shows the array 100 in its folded configuration after it has been substantially completely folded along folding elements 131a-131o, inclusive. As shown, folding may make the array 100 much smaller so that it can be easily stored. One row of the sub-arrays has also been folded over in order to illustrate the versatility of the array 100. The array 100 may also be unfolded and deployed with this structure.

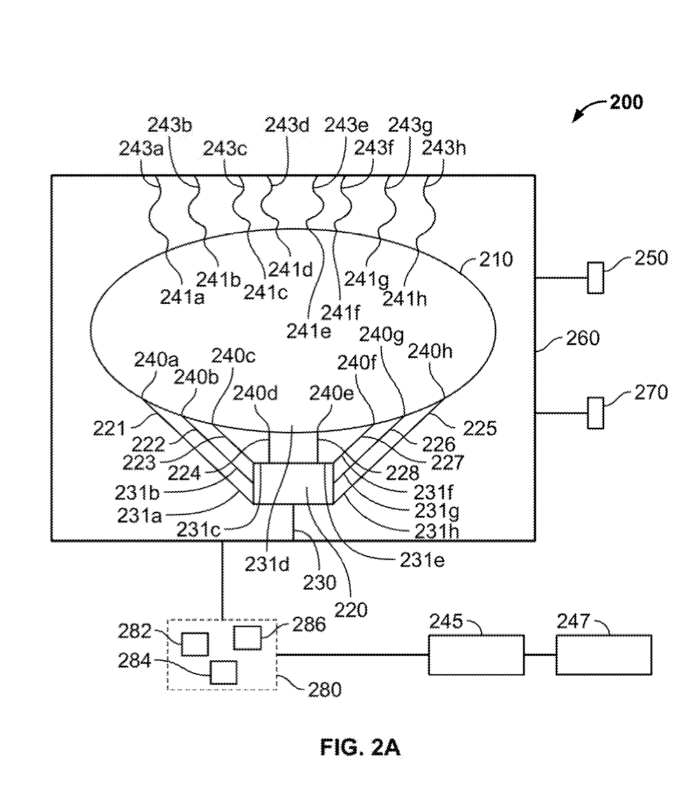

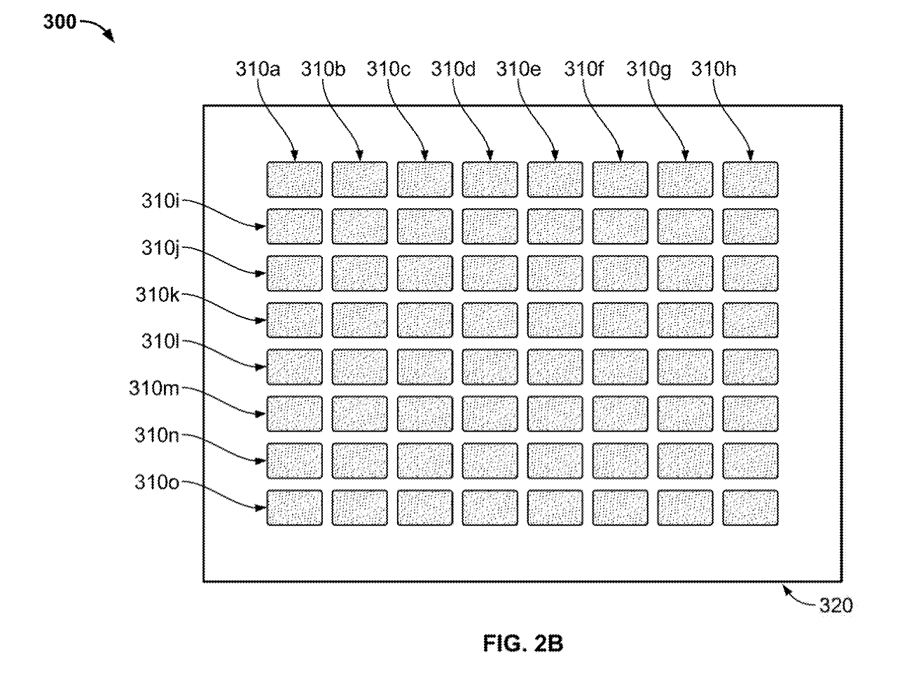

Referring now to FIG. 2A, illustrated are various elements of a sub-array 200 in a large area lightweight electronically scanned array in accordance with one embodiment of the present disclosure. These elements of the sub-array 200 includes a PCRF lens 210, a switch 220 and an input 230.

An example of a PCRF lens 210 is a compact lens sometimes called a Rotman lens, which may be fed a signal by switch 220. Switch 220 selectively connects input 230 to one of outputs 231a, 231b, 231c, 231d, 231e, 231f, 231g, 231h. In this illustration, switch 220 may be a corporate or binary switch tree starting from a single input 230 which can be selectively connected to any compact lens input, positive intrinsic negative (PIN) switch, or a micro-electromechanical switch (MEMS). Switch 220 has a number of outputs 231a, 231b, 231c, 231d, 231e, 231f, 231g, 231h. In the present illustration, the number of outputs is eight (8). However, it should be understood that the number of outputs could also be 2, 4, 16 or a larger number. A single switch, e.g., switch 220, or multiple switches (not shown) may be used as part of the sub-array 200. The number of switches and/or switch positions may be determined by one of ordinary skill in the art.

PCRF lens 210 may perform a beam forming operation on an RF signal sent from single input 230 through one of PCRF lens inputs 240a, 240b, 240c, 240d, 240e, 240f, 240g, 240h. PCRF lens 210 may then deliver tuned or adjusted signals having the desired phase shift, adjusted path length or time delay (when compared to the RF signal input at input 230) through PCRF lens outputs 241a, 241b, 241c, 241d, 241e, 241f, 241g, 241h]. PCRF lens outputs 241a, 241b, 241c, 241d, 241e, 241f, 241g, 241h may be operably coupled via bootlaces 243a, 243b, 243c, 243d, 243e, 243f, 243g, 243h and some form of waveguide to radiating elements (not shown in FIG. 2A).

Each signal may be delivered to the sub-array 200 via co-planar waveguide 245 from a signal source 247. Signal source may be, for example, a communication radio, a radar signal generator or an arbitrary waveform generator. In the present illustration, a single input 230 is shown. Input 230 is a switch input. However, it should be understood that multiple inputs could be provided as part of the switch 230.

In the present illustration, bootlaces 243a, 243b, 243c, 243d, 243e, 243f, 243g, 243h are coupled via waveguides to eight (8) PCRF outputs 241a, 241b, 241c, 241d, 241e, 241f, 241g, 241h from the compact lens 210. The PCRF outputs 241a, 241b, 241c, 241d, 241e, 241f, 241g, 241h facilitate the steering of radio frequency waves so that when the radio frequency waves go out through radiating elements (not shown in FIG. 2A), the radio frequency waves go to a particular direction in space.

Computer-executable instructions may reside on a processor 250 connected to circuit board 260. Circuit board 260 may be small, e. g., two feet by one and a half feet (2′×1.5′). Memory 270 can also be coupled to circuit board 260. The sub-array 200 may operate in a practical frequency range of 1 GHz to 100 GHz. In the present example, the sub-array 200 is operating at 3 GHz. Not shown are digital signals that need to attach to the switch 220. The signals could arrive via separate cable or via traces on circuit board 260. Digital lines tell switch 220 which port to switch to. With three bits of information, one could specify eight (8) different switch positions. At the other end of the digital lines may be a computer having a processor 250. If switch 220 had sixteen (16) outputs instead of eight (8) as shown, one would need four (4) bits of information which indicate the direction in space the sub-array 200 should point.

The sub-array 200 may have tuning or adjustment capabilities that permit it to adjust the phase, time delay or path length of output signals to create a large array pattern with a narrower beam than produced by any of the individual sub-arrays alone. To this end, relative tuning device 280 may be or include a phase shifter 282, a path length adjuster 284 and/or a digital time delay 286.

Phase shifters, e.g., phase shifter 282 are known in the art and commercially available. Relatively narrow bands of frequencies can be covered by phase shifters. Phase shifter 282 may be a digital radio frequency phase shifter. Phase shifter 282 can be used to control the relative radio frequency phase of a signal going through one sub-array in relation to another sub-array. It may be desirable for phase shifter 282 to cover three hundred sixty degrees (360°) of phase shift. In this manner, phase shifter 282 is capable of shifting the phase across essentially any angle.

The phase shifter 282 may allow the phase or amplitude of a signal passing through the sub-array 200 to be adjusted in a number of different application environments. For example, in space, the phase (or up-and-down cycles of the signal) could be adjusted while a spacecraft is up in orbit. One way to do this is to transmit a beam to Earth and then characterize how the beam hits Earth, then remotely control the phases to tune up the phases while the spacecraft is in orbit. If the large area lightweight electronically scanned array were unfolded, yet still not flat, the phase shifter could be used to adjust the signal to account for the lack of flatness of the large area lightweight electronically scanned array. The phase shifter 282 may be designed to shift only over one cycle, e.g., 0-360 degrees. By setting a phase, one may be able to choose that number within the range of 0-360 degrees, in order to obtain a desired signal.

Each sub-array 200 emits a beam. If one sub-array 200 has a twenty (20) foot beam, four (4) similar sub-arrays would result in a narrower beam so that the power is more concentrated in a particular direction in space. One could steer the beam by changing the relative phases and steer within the twenty (20) feet. For an array with sixty-four (64) sub-arrays, there would be sixty-three relative phases.

Thus, where the phase of one sub-array signal were known, the system could shift the phase of one or more other signals for other sub-arrays relative to the known signal for the first sub-array. The phase shift could be predetermined according to the desired beam pattern. Measuring the array pattern may be desirable here as well. By measuring the array pattern, one can determine how tall and wide the resulting beam is.

In another tuning embodiment, the sub-arrays could all be turned off except for two. Then, one could adjust the phase of the second sub-array until it acts in accordance with plans. Then, one could fire up the third sub-array, tweak and optimize it, and so on, until all the arrays perform as desired. For example, it may be desirable to have a particular radiative pattern. The arrays could be tuned to produce such a radiative pattern, resulting in a desired beam height and width. In lieu of shifting the phase, the system could adjust the path length. Adjusting the path length can be accomplished by path length adjuster 284, which may be configured to adjust the path length of each waveguide that feeds a signal to each of the sub-arrays over a larger band of frequencies when compared to phase shifting. One way of adjusting the path length is by physically running it through a circuit that can give different path lengths.

The system could also adjust the path length through a digital time delay as an alternative to a physical long path length. One could take an analog signal that has some value as a function of time. One can take that signal, digitize it and represent the analog signal with a digital representation, e.g., a voltage versus time waveform. This representation could be stored in computer memory 270. Later, the large area lightweight electronically scanned array 200 could read those numbers back out as digital numbers and convert them back to an analog signal. Hence, the RF waveform would be reproduced later in time. Essentially, this time delay for signal reproduction serves the same function as a physical device that provides a path delay to a signal. The advantage in this approach is that long delay times (equivalent to very long physical delay paths) can be virtually created which are light and inexpensive.

These types of delay paths can be used in lieu of physical delay paths, which are generally heavy, expensive and can severely attenuate the signal. Time delay capabilities can be accomplished by time delay 286, which may be a digital or analog time delay circuit. Time delay 286 can enable the array to properly operate to electronically steer beams over a broader range of frequencies than phase shifter 282.

It is known in the art that when phase shifting is used for beam steering, improper steering can occur. This improper steering is due to a problem known as “squint”, where frequency components are far from the center frequency. Such improper steering can be addressed with a time delay. A digital time delay, e.g., time delay 286, may be used to create the equivalent of a long delay line. In this case, memory 270 should be sufficient to store the equivalent amount of time. For example, if an electromagnetic RF signal travels through sub-array 200 at the speed of light, one nanosecond is one foot. If the antenna were fifty (50) feet long, that would be the equivalent of about fifty (50) nanoseconds of time delay. One could make a compact equivalent of a long physical delay line by taking an analog signal, digitizing it in memory, and pulling the signal out later in time, e.g., 50 nanoseconds later. As is known in the art, time delay and phase shifts are related concepts. For example, a ninety degree (90°) phase shift is essentially the same as a ¼ cycle time delay.

Referring now to FIG. 2B, illustrated is a plurality of antenna radiating elements for a large area lightweight electronically scanned array in accordance with one embodiment of the present disclosure. The present illustration shows an eight by eight (8×8) radiating element array, with eight rows and eight columns. The eight columns are headed by radiating elements 310a, 310b, 310c, 310d, 310e, 310f, 310g, 310h. The eight rows are aligned with radiating elements 310a, 310i, 310j, 310k, 310l, 310m, 310n, 310o. The radiating elements may be slot coupled patch antenna elements or other radiating elements known in the art. Slot coupled patch antenna elements may be suitable where thin profile is of primary concern, minimal mass is important, and thirty percent (30%) fractional bandwidth is adequate for the applications. Slot coupled patch antennas are known in the art.

In lieu of slot coupled patch elements, Vivaldi slot elements (or Vivaldi radiating elements) may be used, particularly in instances where multiple octaves of bandwidth are required. For example, the range of frequency for Vivaldi slot elements can range from two (2) to twenty (20) GHz. Vivaldi slot elements are known in the art.

Following are example details regarding the radiating elements for a sub-array at three Gigahertz (3 GHz). The size of circuit board 320 may be two feet by one and one-half feet (2′×1½′). If the radiating elements totaled thirty-two (i.e., eight elements wide by four elements tall) instead of sixty-four (64) as shown, the gain may be about twenty dBi, and the beam may be about twelve degrees (12°) wide by twenty degrees (20°) tall.

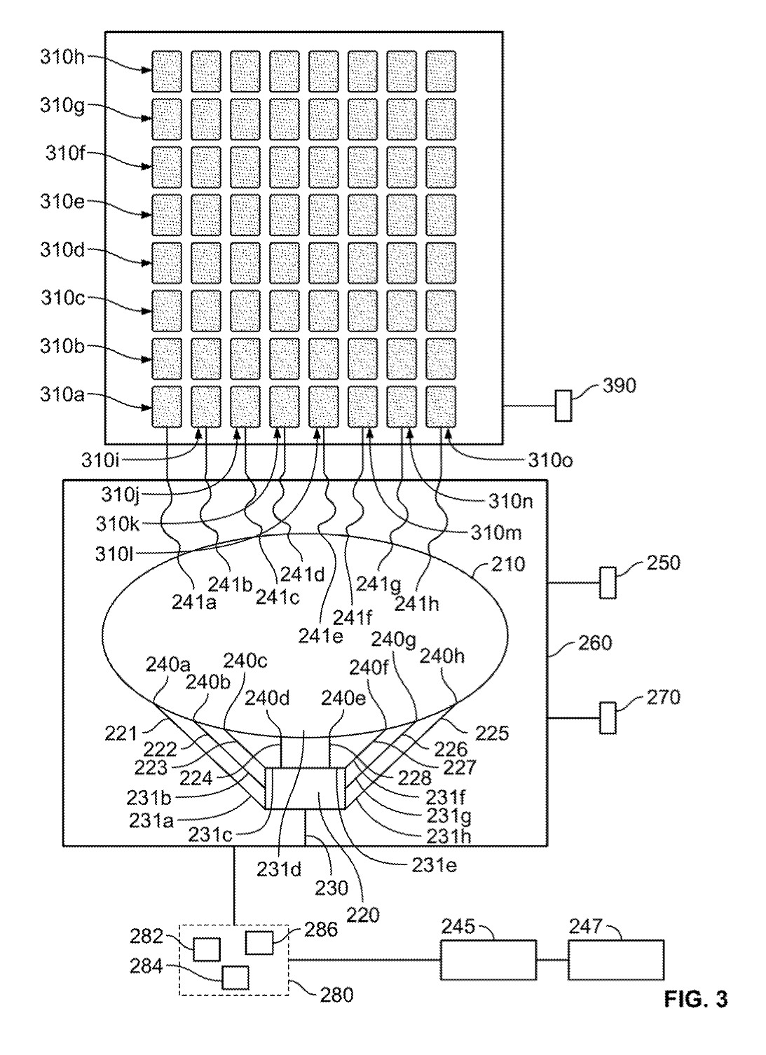

Referring now to FIG. 3, illustrated is an individual sub-array that shows the connections between PCRF outputs 241a, 241b, 241c, 241d, 241e, 241f, 241g, 241h and a plurality of radiating elements 310a, 310i, 310j, 310k, 310l, 310m, 310n, 310o in accordance with one embodiment of the present disclosure. Here, the sub-array 200 includes eight radiating elements 310a, 310i, 310j, 310k, 310l, 310m, 310n, 310o. However, it should be understood that the sub-array 200 could include be operably coupled to, or include, one radiating element or any number of radiating elements deemed by one of ordinary skill in the art to be suitable for a particular application. It should be noted that if a 16×4 array of sub-arrays has eight radiating elements for each sub-array, the number of radiating elements required could be five hundred twelve (512). A target tuning receiver 390 is shown behind the sub-array 200. In receive mode, all the outputs of all of the sub-arrays, e.g., 200, feed waveguides that become combined (i.e., the lines all get joined together) to sum up all the signals into one waveguide which then feeds the target tuning receiver 390. The target tuning receiver 390 can be located anywhere near the array 200, including behind it. The target tuning receiver 390 just has to be close enough so the combined received signals can be fed into it.

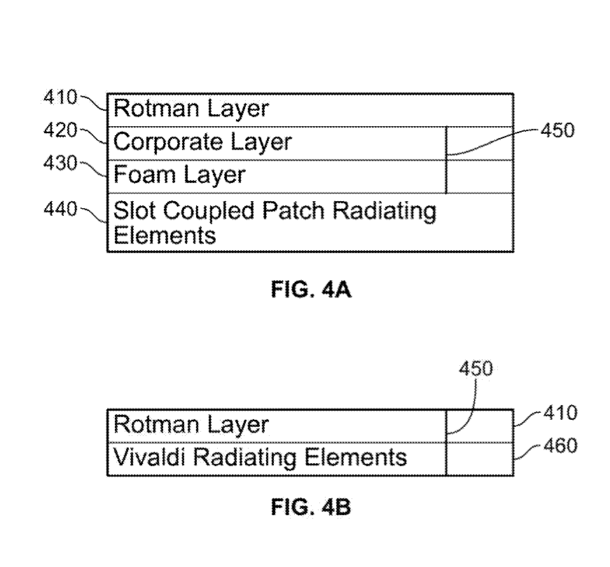

FIGS. 4A and 4B are block diagram representations of the various layers of the large area lightweight electronically scanned array in accordance with one embodiment of the present disclosure. Referring now to FIG. 4A, this block diagram pertains to a large area lightweight electronically scanned array that includes slot coupled patch elements as radiating elements in accordance with one embodiment of the present disclosure. Rotman layer 410 is at the top and includes the PCRF lenses. Rotman layer 410 connects to a corporate splitter layer 420. Corporate splitter layer 420 is a switch layer that illustrates how a switch may be a corporate or binary switch tree starting from a single input which can be selectively connected to any compact lens input at the Rotman layer 410. Both the Rotman layer 410 and the corporate splitter layer 420 may be printed circuit boards (PCBs). At the end of the corporate splitter layer 420 is foam layer 430, which acts as a spacing layer. Next to the foam layer 430 is slot coupled patch layer 440, which includes the radiating elements. One or more of the layers 410, 420, 430, 440 may be folded to facilitate storage and space-saving.

Foam layer 430 may reside between Rotman layer 410 and radiating elements at the slot coupled patch layer 440. Foam layer 430 provides physical spacing between Rotman layer 410 and slot coupled patch layer 440. For example, at 3 GHz this spacing needs to be at least roughly one (1) inch or else the efficiency and effectiveness of the radiating elements may be diminished. A person of ordinary skill in the art would be able to determine the spacing needed to maximize the efficiency and effectiveness of the radiating elements. The foam layer 430 may be rigid, low cost and lightweight. In lieu of foam, aerogel may be used. A connection 450 may reside between the Rotman layer 410 and the slot coupled patch layer 440. A co-planar wave guide (e.g. ½ oz copper on polyimide sheet) may be used as the connection 450. A co-planar waveguide may be particularly useful as connection 450 when very low mass is required. The co-planar waveguide is also particularly suitable for use in conjunction with the slot coupled patch layer 440. A co-planar waveguide may also be particularly useful due to its flexibility, which may facilitate foldability of the device when not in use. Alternative modes of operably coupling the Rotman layer 410 and the slot coupled patch layer 440—other than a co-planar waveguide—are known in the art.

In lieu of a coplanar waveguide, a vertical interconnect access (VIA) may be particularly useful when a monolithic assembly is desired (more compact). A VIA is a hole in a circuit board that has a conductor plated inside the hole. A VIA configuration may be similar to putting a wire through the circuit board.

Referring now to FIG. 4B, if Vivaldi radiators are used, then only two layers may be needed. The Rotman layer 410 could operably couple directly to the Vivaldi radiating elements 460. A coplanar waveguide 450 may be used to connect the Rotman layer 410 to the Vivaldi radiating elements 460.

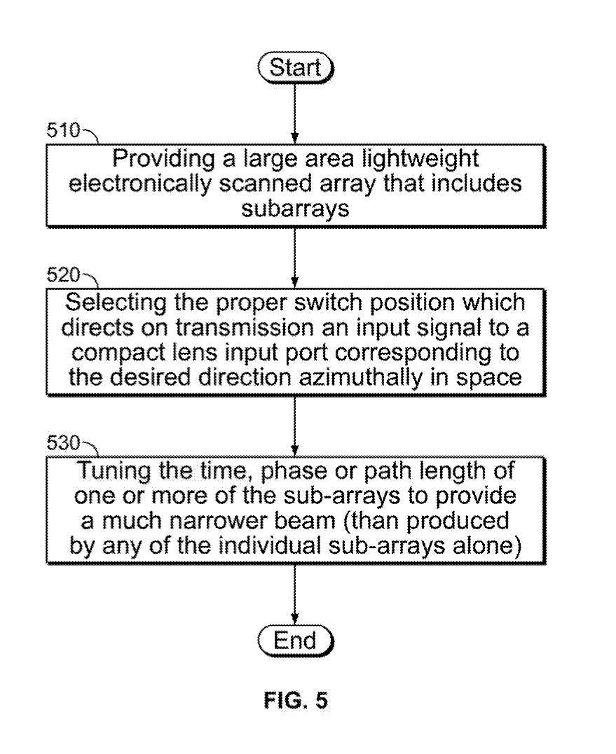

FIG. 5 is a flow chart of a method for steering a large area lightweight electronically scanned array in accordance with one embodiment of the present disclosure.

At step 510, a large area lightweight electronically scanned array is provided. The array includes a sub-array subsystem that has a plurality of sub-arrays. The array also includes a relative tuning device that is operably coupled to the plurality of sub-arrays. The array still further includes a relative tuning device that has a processor having instructions for adjusting phase, path length or time delay of a signal for one of the plurality of sub-arrays relative to a signal of another of the plurality of sub-arrays. The relative tuning device still further includes memory for storing those instructions for adjusting phase, path length or time delay of a signal for one of the plurality of sub-arrays relative to a signal for another of the plurality of sub-arrays.

At step 510, the sub-arrays are configured to electronically steer the large area lightweight electronically scanned array. Each sub-array includes a PCRF lens having at least one PCRF lens input port, a switch and PCRF outputs. A plurality of radiating elements are connected directly to the PCRF outputs via bootlaces. A signal delivery device may send signals to the sub-arrays.

At step 520, the sub-arrays are pointed to facilitate electronic steering of the array. Coarse angular pointing can be done by mechanically orienting the plane of the large array. Fine angular pointing can be done electronically by selecting the proper switch position which directs (on transmission) an input signal to a PCRF lens input corresponding to the desired direction azimuthally in space. At this point, a rather large two-dimensional angle in space has been selected.

At step 530, the relative tuning device is adjusted to create the large array pattern. This large array has a much narrower beam (than produced by any one of the individual sub-arrays). In this regard, the radio frequency beam may begin to look more like a laser beam. The adjustable relative tuning device may adjust the phase, path length or time delay of one sub-array in the plurality of sub-arrays in relation to another sub-array in the plurality of sub-arrays. Note that while the sub-arrays can only electronically steer in the azimuthal angle, the large array can electronically steer in both the azimuthal angle and in the elevation angle (though the extent of electronic elevation steering will be necessarily limited to the width of the sub-array beam width). Electronic steering is valuable because it can be very fast when compared with mechanical steering.

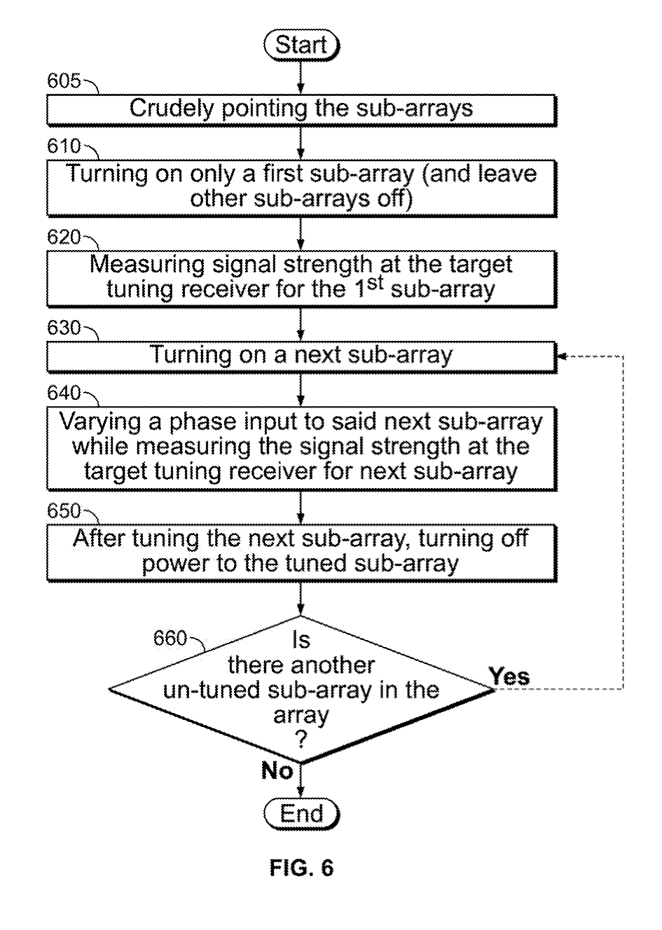

Referring now to FIG. 6, illustrated is a method for relatively tuning an array in accordance with one embodiment of the present disclosure. At step 605, the sub-arrays need to be crudely pointed. That is done by switching to the proper beam port (i.e. the beam which corresponds approximately to the direction in space for the target tuning receiver)

At step 610, the method includes turning on a first sub-array. The remaining sub-arrays are left turned off. For example, if there are sixty-four (64) sub-arrays, then one sub-array would be turned on, while the remaining sixty-three (63) sub-arrays are turned off. At step 620, the method includes measuring, at the tuning receiver, the signal strength at the target tuning receiver for the first sub-array. In receive mode, all the outputs of all of the sub-arrays feed waveguides that become combined (the lines all get joined together) to sum up all the signals into one waveguide which then feeds the receiver. The target tuning receiver can be located anywhere near the array (including behind it). It just has to be close enough so the combined received signals can be fed into it. As an option for tuning, the first sub-array may be turned off after tuning, but it may be desirable to leave it on. To do phase tuning we need a pair of sub-arrays. So we need to always have a “reference” sub-array turned on and then turn on one other sub-array (one at a time) to do the one at a time phase tuning.

The reason for tuning with only one pair at a time is that the sensitivity of the tune will be maximized and the most accurate tune can be obtained. Ultimately after all the sub-arrays are tuned up or pointed by phasing, then all the sub-arrays should be turned on to use the system. At step 630, the method includes turning on the next sub-array. In the case where there are sixty-four (64) sub-arrays or any other number of sub-arrays, the second sub-array would be turned on. At step 640, the method includes varying a phase input to said next sub-array while measuring the signal strength at the target tuning receiver for the next sub-array. Here, the next sub-array was the second sub-array. Therefore, the phase input would be varied for the second sub-array while measuring the signal strength at the target tuning receiver for the second sub-array.

At step 650, the method includes, after tuning the next sub-array, turning off power to the tuned sub-array. In this case, after tuning the second sub-array, the power would be turned off to the tuned second sub-array. Turning off each tuned sub-array may provide for more accurate tuning since the relative power output from the tuning is expected to have greater dynamic range than for omitting the step of turning off each sub-array, and instead, leaving the sub-array in a power-on state after it has been tuned. Optionally, the method may delete this step 650 of turning off each tuned sub-array.

At step 660, the method includes determining whether there is or is not another un-tuned sub-array. In the present example, there are sixty-four sub-arrays and only two have been tuned. Therefore, sixty-two sub-arrays would be unturned at this point. In this case, the answer would be “yes,” i.e., there remains another untuned sub-array. Therefore, the method would include repeating steps 630-660 until all sixty-four sub-arrays were tuned.

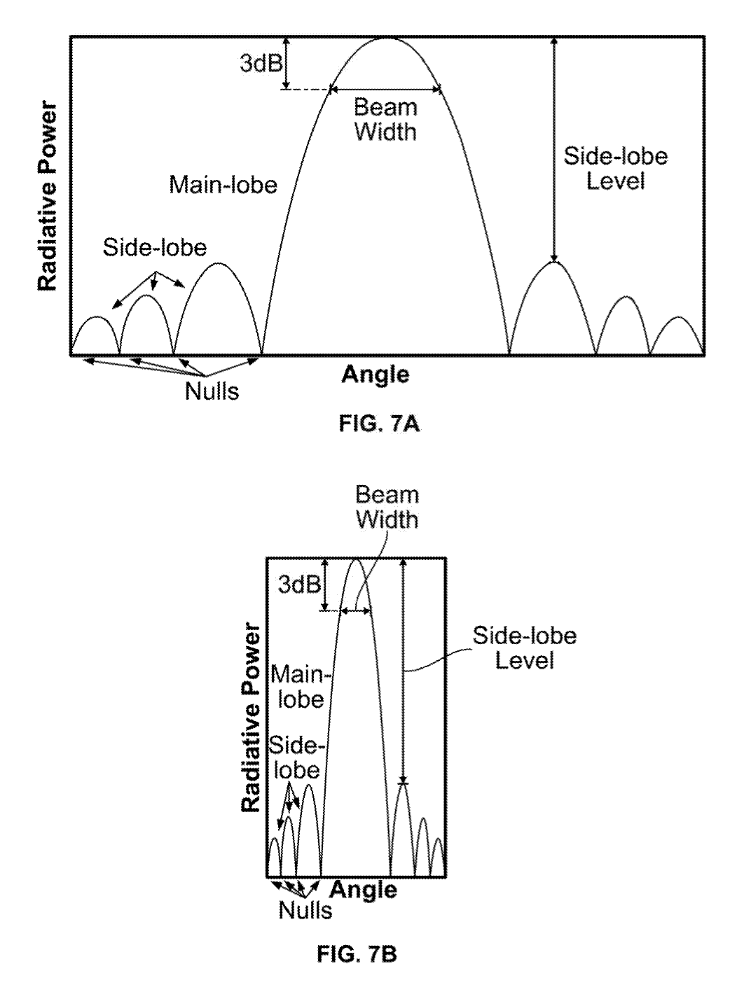

Referring now to FIGS. 7A and 7B, illustrated is an example of the contrast between beam patterns that may be created by individual array versus beam patterns that may be created by a plurality of sub-arrays. In FIG. 7A, radiative pattern is illustrated as a function of angle for an individual sub-array. The pattern is about eight degrees (8°) wide. The side lobes of the radiative pattern are similar in proportion to the main lobe. By contrast, FIG. 7B illustrates the pattern for a plurality of sub-arrays. When the plurality of sub-arrays are used, the pattern is narrower. Both the main lobe as well as the side lobes illustrate a narrower radiative pattern in FIG. 7B than that in FIG. 7A. In the present illustration, the radiative pattern for the plurality of sub-arrays is only about one degree (1°) wide. Thus, with a plurality of sub-arrays, the beam is narrower.

The large area lightweight electronically scanned array described herein has a number a number of different applications. For example, it may be used in satellite applications, e.g., for spacecraft. This lightweight array may be particularly attractive since mass is very expensive to put into orbit. Moreover, the array has space-saving features. It can be easily folded for stowage within a launch vehicle.

The array can be used with large, lighter than air vehicles, e.g., blimps. The array is light enough to be lifted by a blimp. Moreover, the antenna can be completely contained within the envelop of the blimp, thus affording other system advantages. Examples of such advantages include good aerodynamics and no increase in observability.

The array is thin, and can therefore be built into other structures without taking up much space. For example, the array may be used with moving vans or other large trucks. Because the array is thin, it can be built into the side of these large land vehicles. The array can be used for billboards or other electronic display media. The array can be very thin and therefore built into the display media and thus hidden in plain sight. Because the array is thin, it can also be built into structures such as building or other large fixed structures.

The foregoing description of various embodiments has been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A large area lightweight electronically scanned array, comprising:
a plurality of sub-arrays, each said sub-array including:
at least one radiating element;
a planar, constrained radio frequency lens having an input and at least one output, wherein the at least one output is operably coupled to the at least one radiating element;
a switch device, the switch device having at least one input and an output, the switch device being configured to transmit a signal to the input of the planar, constrained radio frequency lens and to selectively couple a signal source to the input of the planar, constrained radio frequency lens; and
a relative tuning device that is configured to adjust a phase, path length or time delay of signals received from a signal source to the input of the planar, constrained radio frequency lens relative to another signal received from a signal source to the input of another planar, constrained radio frequency lens in one of the plurality of sub-arrays, the relative tuning device including:
a processor having instructions for adjusting at least one of phase, path length or time delay of signals received from a signal source to the input of the planar, constrained radio frequency lens a signal relative to another signal received from a signal source to the input of another planar, constrained radio frequency lens in one of the plurality of sub-arrays; and
memory for storing said instructions for adjusting phase, path length or time delay of signals received from a signal source to the input of the planar, constrained radio frequency lens a signal relative to another signal received from a signal source to the input of another planar, constrained radio frequency lens in one of the plurality of sub-arrays.

2. The array of claim 1, wherein the array is arranged to be in a folded configuration when not in use, and an unfolded configuration when in use.

3. The array of claim 1, wherein the relative tuning device is a phase shifter, path length adjuster or time delay circuit.

4. The array of claim 1, further comprising:
a spacing layer between the planar, constrained radio frequency lens and the at least one radiating element.

5. The array of claim 4, wherein the at least one radiating element is a slot coupled patch element.

6. The array of claim 4, wherein the spacing layer is a foam layer.

7. The array of claim 1, wherein the at least one radiating element is a Vivaldi slot element.

8. The array of claim 1, further comprising a signal delivery device configured to feed a signal from a signal source to the plurality of sub-arrays, and wherein the signal delivery device is a waveguide that is operatively coupled to the sub-array.

9. The array of claim 8, wherein the signal source is a radar signal generator.

10. The array of claim 8, wherein the signal source is an arbitrary waveform generator.

11. The array of claim 8, wherein the waveguide is a coaxial cable.

12. The array of claim 8, wherein the waveguide is a co-planar waveguide.

13. A method for electronically steering a large area lightweight electronically scanned array, the method comprising the steps of:
providing an array that includes:
a plurality of sub-arrays each said sub-array including:
at least one radiating element;
a planar, constrained radio frequency lens having an input and at least one output, wherein the at least one output is operably coupled to the at least one radiating element;
a switch device, the switch device having at least one input and an output, the switch device being configured to transmit a signal to the input of the planar, constrained radio frequency lens and to selectively couple a signal source to the input of the planar, constrained radio frequency lens; and
a relative tuning device that is configured to adjust a phase, path length or time delay of signals received from a signal source to the input of the planar, constrained radio frequency lens relative to another signal received from a signal source to the input of another planar, constrained radio frequency lens in one of the plurality of sub-arrays, the relative tuning device including:
a processor having instructions for adjusting at least one of phase, path length or time delay of signals received from a signal source to the input of the planar, constrained radio frequency lens relative to other signals received from a signal source to the input of another planar, constrained radio frequency lens in one of the plurality of sub-arrays; and
memory for storing said instructions for adjusting phase, path length or time delay of signals received from a signal source to the input of the planar constrained radio frequency lens relative to other signals received from a signal source to the input of another planar constrained radio frequency lens in one of the plurality of sub-arrays;
feeding a signal from a signal source to the plurality of sub-arrays;
electronically steering the array by pointing the sub-arrays, including by:
selectively coupling an input signal to a compact lens input of one of the plurality of sub-arrays, the planar constrained radio frequency lens input corresponding to an azimuthal direction; and
tuning the signals received from the signal source to the input of the planar, constrained radio frequency lens relative to other signals received from the signal source to the input of another planar constrained radio frequency lens in one of the plurality of sub-arrays, wherein the input of each planar, constrained radio frequency lens corresponds to the azimuthal direction.

14. The method of claim 13, wherein the tuning step includes:
a. activating one of the plurality of sub-arrays;
b. measuring a signal strength of a target tuning receiver at the one of the plurality of sub-arrays;
c. activating another sub-array in the plurality of sub-arrays;
d. varying a phase input to said another sub-array, and substantially simultaneously, measuring another signal strength at the another tuning receiver for another sub-array;
e. de-activating the another sub-array;
f. repeating steps c-e for each sub-array in the plurality of sub-arrays, until steps c-e have been performed for all the another sub-arrays in the plurality of sub-arrays.

15. The method of claim 13, wherein the array is arranged to be in a folded configuration when not in use, and an unfolded configuration when in use.

16. The method of claim 13, wherein the at least one radiating element is a slot coupled patch element.

17. The method of claim 13, wherein the at least one radiating element is a Vivaldi slot element.

18. A large area lightweight electronically scanned array, comprising:
a substrate;
a plurality of sub-arrays operably coupled to the plurality of radiating elements, each sub-array being interconnected with at least one other sub-array, each said sub-array including:
at least one radiating element;
a planar, constrained radio frequency lens; having an input and at least one output, wherein the at least one output is operably coupled to the at least one radiating element;
a switch device, the switch device having at least one input and an output, the switch device being configured to transmit a signal to the input of the planar, constrained radio frequency lens and to selectively couple a signal source to the input of the planar, constrained radio frequency lens; and
a relative tuning device that is configured to adjust a phase, path length or time delay of a signal received from a signal source to the input of the planar, constrained radio frequency lens relative to another signal received from a signal source to the input of another planar, constrained radio frequency lens in one of the plurality of sub-arrays, the relative tuning device including:
a processor having instructions for adjusting at least one of phase, path length or time delay of a signal received from a signal source to the input of the planar, constrained radio frequency lens a signal relative to another signal received from a signal source to the input of another planar, constrained radio frequency lens in one of the plurality of sub-arrays; and
memory for storing said instructions for adjusting phase, path length or time delay of a signal received from a signal source to the input of the planar, constrained radio frequency lens a signal relative to another signal received from a signal source to the input of another planar, constrained radio frequency lens in one of the plurality of sub-arrays;
a signal delivery device configured to receive a radio frequency signal from the signal source, the signal delivery device being further configured to feed the signal to each of the plurality of sub-arrays;
folding elements configured to cause the array to be arranged in a folded configuration when not in use, and an unfolded configuration when in use.

19. The array of claim 1, wherein the at least one radiating element is a slot coupled patch element.

20. The array of claim 1, wherein the signal delivery device is a waveguide that is attached to the substrate, and the waveguide is a coaxial cable or co-planar waveguide.
